(19) United States
(12) Patent Application Publication
(10) Pub. No.: US 2019/0346682 A1
(43) Pub. Date: Nov. 14, 2019

(54) WEARABLE VR HEADBAND STRUCTURE HAVING AUTOMATIC MECHANISM

(71) Applicant: LG ELECTRONICS INC., Seoul (KR)

(72) Inventors: Timothy KANG, Seoul (KR); Sunghan KIM, Seoul (KR); Bumoh PARK, Seoul (KR); Minho PARK, Seoul (KR)

(73) Assignee: LG ELECTRONICS INC., Seoul (KR)

(21) Appl. No.: 16/474,965

(22) PCT Filed: Dec. 29, 2016
(86) PCT No.: PCT/KR2016/015531

§ 371 Date: Jun. 28, 2019

(51) Int. Cl. G02B 27/01

(52) U.S. Cl. CPC G02B 27/0176; G02B 2027/0169; G02B 2027/0154

(57) ABSTRACT

The present invention relates to a head-mounted display (HMD) device capable of providing content to a user while being worn on the user's head, and provides an HMD device comprising: a body part including a power supply unit for supplying power; a fixing frame mounted on the body part and including a guide member formed adjacent to the body part; a movable member mounted on the fixing frame so as to be movable along the guide member; a length adjustment part mounted on the movable member and including an SMA spring part, which contracts by means of a current applied from the power supply unit so as to move the movable member; and a headband part mounted on the movable member, and moved by the movement of the movable member so as to be suitable for the head size of a human body, wherein the SMA spring part includes a first spring part connected to a first region of the fixing frame adjacent to the guide member, and a second spring part connected to a second region of the fixing frame spaced apart from the first region, with the guide member disposed between the first region and the second region.

### TECHNICAL FIELD

The present disclosure relates to a head-mounted display device that may provide contents to a user while being worn on a user's head.

### BACKGROUND ART

Head-mounted display (HMD) devices refer to various types of image display devices that are worn by users, like glasses, so that the users may view images (contents). As digital devices become lighter and smaller, various wearable computers are being developed, and the HMD devices are also widely used. The HMD devices may provide various convenience to users in combination with augmented reality technology, N-screen technology, etc., beyond a simple display function.

In the related art, when a user wore an HMD device, the user fixed a physical fixing hook or velcro to the user's head. In this case, the user inconveniently needed to undergo a coupling process each time when the user wore the HMD device. In addition, in the related art, the user needed to directly adjust lens distance-related adjusters in the HMD device.

In relation to this, the present disclosure proposes a mechanism structure that automatically adjusts a length of a headband and an adjustment unit in the HMD device, using a spring with a special property (a shape memory alloy (SMA) spring) as an actuator.

### DISCLOSURE

### Technical Problem

One aspect of the present disclosure is to provide a mechanism that automatically adjusts a length of a headband that is in direct contact with a head of a user when the user wears a head-mounted display (HMD) device.

Another aspect of the present disclosure is to provide a structure that helps a user to use an HMD device comfortably, by enhancing the user's comfort in wearing the HMD device.

Another aspect of the present disclosure is to provide an HMD device in which an internal terminal mounting unit may be automatically adjusted.

### Technical Solution

To achieve these and other advantages and in accordance with the purpose of the present disclosure, as embodied and broadly described herein, there is provided a head-mounted display device, the device including: a body part including a power supply unit that supplies power; a fixing frame mounted on the body part and including a guide member provided adjacent to the body part; a length adjustment part including a movable member mounted on the fixing frame to be movable along the guide member and a shape memory alloy spring part that is mounted on the movable member and moves the movable member by being contracted according to current applied from the power supply unit; and a headband part mounted on the movable member and moved according to the movement of the movable member to thereby fit a head size of a human body, wherein the shape memory alloy spring part includes a first spring part coupled to a first region of the fixing frame adjacent to the guide member, and a second spring part coupled to a second region of the fixing frame spaced apart from the first region with the guide member between the first region and the second region.

According to one embodiment of the present invention, the first spring part may move the movable member in a first direction of getting close to the body part, and the second spring part may be disposed to face the first spring part and move the movable member in a second direction of getting away from the body part.

The fixing frame may include a first end and a second end coupled adjacent to a first side and a second side of the body part, respectively, and include a protruding portion that is provided to protrude from one of the first and second ends, wherein the protruding portion may couple the fixing frame to the body part by being inserted into one of the first and second sides corresponding to the protruding portion.

The body part may include a connecting part provided on at least one of the first and second sides to thereby accommodate the protruding portion, and a battery unit in the connecting part to be electrically connected to the first and second spring parts.

The body part may include first and second button units mounted on the connecting part to be pushed by an external force. The first button unit may be electrically connected to the battery unit and the first spring part to transmit a signal to the battery unit so that the first spring part receives current. The second button unit may be electrically connected to the battery unit and the second spring part to transmit a signal to the battery unit so that the second spring part receives current.

The device may include a first housing including a display unit to output a virtual reality image, a second housing, a lens unit disposed in an inner space formed by the first and second housings and including a first lens and a second lens corresponding to a left eye and a right eye of a user, respectively, and a coupling element that couples the first housing to the second housing so that the first housing is slidable with respect to the second housing.

The coupling element may include first and second coupling parts provided on one surface of the first housing, and the second coupling part may include a protruding portion provided to protrude from the one surface of the first housing, and a recess portion recessed in a direction different from a protruding direction of the protruding portion so that the first housing may be mounted to be relatively movable with respect to the second housing.

The second housing may include a third coupling part provided to protrude from the one surface of the second housing to be accommodated in the recess portion, and thus, the first housing may be connected to the second housing when the third coupling part is accommodated in the recess portion.

The coupling element may include a first housing shape memory alloy spring having one end being mounted on the first coupling part and another end being mounted on the one surface of the second housing, and a second housing shape memory alloy spring having one end being mounted on the third coupling part and another end being mounted on the protruding portion, wherein the first and second housing shape memory alloy spring may be formed to be contracted and deformed by the current applied from the power supply unit.

The body part may selectively implement a first state in which the second housing is moved in a direction of getting close to the first housing, as the first spring part is contracted and deformed by the current applied from the power supply unit; and a second state in which the body part is expanded as the second housing is moved in a direction of getting away from the first housing. when the second spring part is contracted and deformed by the current applied from the power supply unit.

The lens unit may include a lens support part to support the first and second lenses, and a moving element that relatively moves the first and second lenses in a same direction or different directions with respect to the lens supporting part, wherein the moving element may include a first lens spring part that moves the first lens in a constant direction and a second lens spring part that moves the second lens in a constant direction.

The body part may further include a memory unit and a controller, wherein the memory unit stores a positional state of the headband part according to a head size of a user and the controller transmits a signal to the power supply unit so that the headband part is arranged in the stored positional state, according to a user's selection, to thereby repeatedly implement a length of the headband part preset by the user.

### Advantageous Effect

The present disclosure provides a shape memory alloy (SMA) spring contracted and deformed by heat so that a headband part is contracted and relaxed according to deformation of the SMA spring, to thereby automatically adjust a length of the headband part.

In addition, since a length of the headband part preset by a user may be repeatedly implemented, a user's wearing comfort may be enhanced. Also, since the headband part gets in contact with an occipital region of the user sequentially step-by-step, the headband part may easily and closely fit the occipital region of the user.

Also, the present disclosure provides such a structure in which a lens distance is automatically adjusted according to the user's operation of a button unit. Thus, terminals with a plurality of sizes may be seated in a terminal mounting unit, and the lens distance may be adjusted so that a user may view images in various sizes even when one display is provided.

### BRIEF DESCRIPTION OF THE DRAWINGS

FIG. 1A is a schematic diagram of a head-mounted display (hereinafter referred to as HMD) device according to an embodiment of the present disclosure.

FIG. 1B is an exploded perspective view of FIG. 1A.

FIGS. 2A and 2B are diagrams illustrating a first state viewed from different directions, respectively, in which a headband part in the HMD device is moved in a direction of getting close to a body part according to an embodiment of the present disclosure.

FIGS. 3A and 3B are diagrams illustrating a second state viewed from different directions, respectively, in which the headband part in the HMD device is moved in a direction of getting away from the body part according to an embodiment of the present disclosure.

FIG. 4 is an exploded perspective view of the body part in the HMD device according to an embodiment of the present disclosure.

FIGS. 5A and (a) of 5B illustrate the first state in which first and second housings are coupled to each other and the second state in which the first and second housings are separate from each other, and thus, the body part is expanded, respectively, in the HMD device according to an embodiment of the present disclosure. (b) of FIG. 5B is a diagram illustrating the second state of (a) of FIG. 5B viewed from another direction.

FIGS. 6A and 6B are diagrams of a lens unit in the HMD device according to an embodiment of the present disclosure.

### MODES FOR CARRYING OUT THE PREFERRED EMBODIMENTS

Description will now be given in detail according to exemplary embodiments of a head-mounted display (HMD) device according to the present disclosure, with reference to the accompanying drawings.

In describing the present disclosure, if a detailed explanation for a related known function or construction is considered to unnecessarily divert the gist of the present disclosure, such explanation has been omitted but would be understood by those skilled in the art. It will be further understood that the terms “includes,” and/or “including,” when used herein, specify the presence of components, but do not preclude the presence or addition of one or more other components, unless otherwise specified. Additionally, terms used herein, such as “unit” or “module”, mean entities for processing at least one function or operation. These entities may be implemented by hardware, software, or a combination of hardware and software.

One aspect of the detailed description provides a mechanism that automatically adjusts a length of a headband that is in contact with a head of a user to enhance the user's wearing comfort so that the user uses HMD device comfortably when the user wears the HMD device.

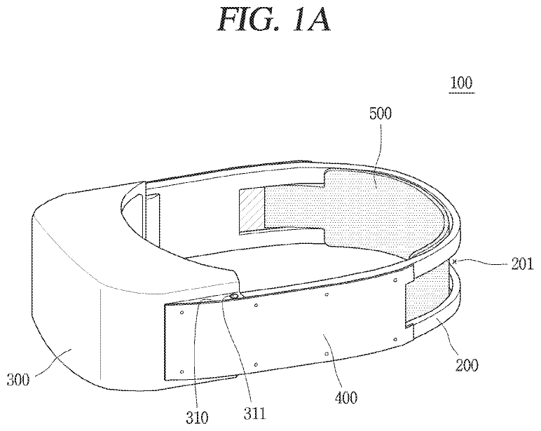

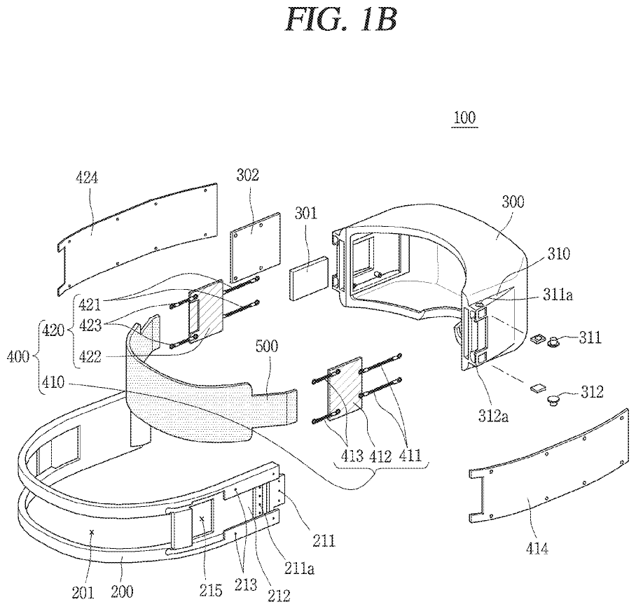

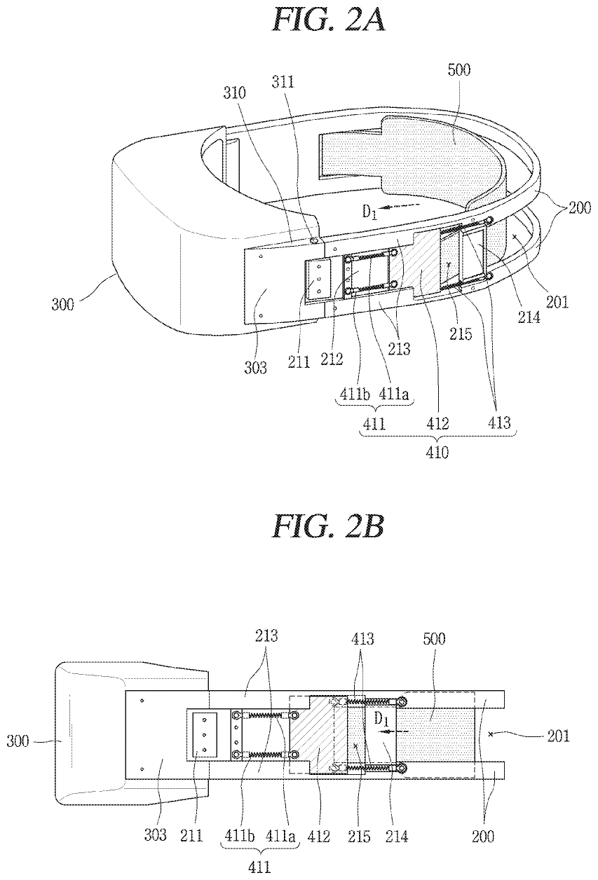

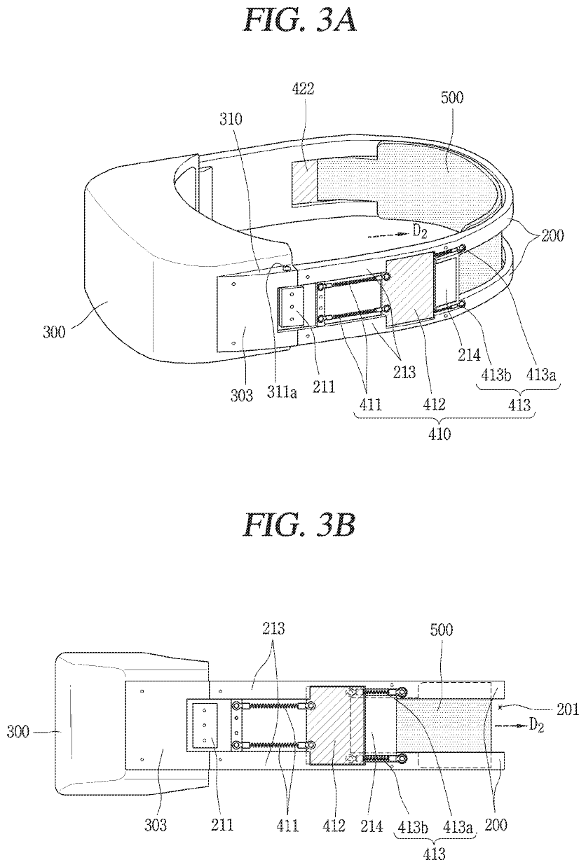

Hereinafter, referring to FIG. 1, configurations of the HMD device are described. Referring to FIGS. 2 and 3, a mechanism in which the headband is extended or contracted so that the headband is in contact with the user's head are described.

FIG. 1A is a schematic diagram of a head-mounted display device 100 according to an embodiment of the present disclosure.

Referring to FIG. 1A, the head-mounted display (hereinafter referred to as HMD) device 100 according to an embodiment of the present disclosure includes a body part 300 including a display unit (not shown) to output a virtual reality image, a fixing frame 200 mounted on the body part 300, a length adjustment part 400 mounted on the fixing frame 200, and a headband part 500 that is directly in contact with a user's occipital region and mounted on the length adjustment part 400.

The display unit is mounted on the head and displays an image directly in front of the user's eyes. When the user wears the HMD device 100, the display unit may be disposed to correspond to at least one of a left eye and a right eye of the user so that the image is provided directly in front of the user's eyes when the user wears the HMD device 100.

The body part 300 may be worn on at least a portion of the user's face, for example, a face surface and supported on the users face by various components.

The body part 300 may include a front surface constituting an outer appearance and a rear surface disposed in a position opposite to that of the front surface. The rear surface is a portion in contact with the face surface of the user, and may include a nose recess having a shape of a nose so that a nose of the user is located therein. An elastic body may be disposed adjacent to the nose recess.

The fixing frame 200 is coupled to the body part 300. With respect to a coupling method, the fixing frame 200 may be physically coupled to the body part 300 in a form of a hook, etc. Alternatively, the fixing frame 200 may be coupled to the body part 300 using a method using a magnet or an electromagnet.

The length adjustment part 400 is mounted inside the fixing frame 200 to be relatively movable with respect to the fixing frame 200. The length adjustment part 400 may be connected to the headband part 500 to move the headband part 500 in one direction or in another direction.

The headband part 500 is disposed at one side of the fixing frame 200 to face the body part 300, and connected to the length adjustment part 400 so that the headband part 500 may be moved according to the movement of the length adjustment part 400.

That is, the length adjustment part 400 is mounted at one side of the fixing frame 200 to be relatively movable with respect to the fixing frame 200. According to the movement of the length adjustment part 400, the headband part 500 may move with respect to the fixing frame 200 in one direction of getting close to the body part 300 or in another direction of getting away from the body part 300.

As shown in FIG. 1A, the body part 300 may include a first button unit 311 at one side of the body part 300. The first button unit 311 is electrically connected to a power supply unit 301 that will to be described later and the length adjustment part 400.

When the user pushes the first button unit 311, the first button unit 311 may apply a signal to the power supply unit 301. Then, the power supply unit 301 may supply current to the length adjustment part 400.

In addition, the length adjustment part 400 may include a spring formed of a shape memory alloy (SMA) that may be contracted and deformed by heat. In this case, the SMA spring included in the length adjustment part 400 may be contracted and deformed according to current applied from the power supply unit 301 and relatively moved with respect to the fixing frame 200, Resultantly, the headband part 500 connected to the length adjustment part 400 may relatively move with respect to the fixing frame 200.

Therefore, the headband part 500 may be deformed in a direction extending or contracting with respect to the body part 300 and the fixing frame 200 according to a size of the occipital region of the user.

FIG. 1B is an exploded perspective view of FIG. 1A.

Referring to FIG. 1B, the fixing frame 200 may include a first end coupled adjacent to a first side of the body part 300 and a second end coupled adjacent to a second side of the body part 300, the second side being disposed to face the first side of the body part 300. The first and second ends may be disposed to face each other.

The fixing frame 200 may include a protruding portion 211 to couple the body part 300 to the fixing frame 200. The fixing frame 200 may include a guide member 213 provided adjacent to the body part 300. The guide member 213 may be provided on at least one of the first and second ends of the fixing frame 200.

The protruding portion 211 is provided to extend and protrude from one of the first and second ends in a direction toward the body part 300. Then, the protruding portion 211 is inserted into, and thus, coupled to one of the first and second sides of the body part 300 in correspondence with the protruding portion 211 to thereby couple the body part 300 to the fixing frame 200.

The body part 300 may further include a connecting part 310 provided to accommodate the protruding portion 211. The connecting part 310 may be provided on at least one of the first and second sides of the body part 300 in correspondence with the protruding portion 211.

The fixing frame 200 may include an intermediate portion (not shown) provided between the first and second ends of the fixing frame 200 and corresponding to a central portion of the occipital region of the user. The intermediate portion may include an edge region and a vent hole 201, wherein the edge region extends from the first and second ends of the fixing frame 200 and the vent hole 201 is surrounded by the edge region.

The vent hole 201 exposes at least a part of the headband part 500, which is to be described later, to outside of the fixing frame 200 to thereby facilitate ventilation of the headband part 500.

The fixing frame 200 may further include a band hole 215 in addition to the vent hole 201. A movable member 412 that is to be described later is mounted on the guide member 213 provided on an outer side of the fixing frame 200. To mount the headband part 500 on an inner side of the fixing frame 200 and connect the headband part 500 to the movable member 412, the headband part 500 needs to penetrate into the inner side and the outer side of the fixing frame 200. Therefore, through the band hole 215, the headband part 500 may penetrate into the inner side and the outer side of the fixing frame 200 and be connected to the movable member 412.

Referring to FIG. 1B, the length adjustment part 400 may include a first length adjuster 410 mounted adjacent to the first end of the fixing frame 200, and a second length adjuster 420 mounted adjacent to the second end of the fixing frame 200. The first length adjuster 410 and the second length adjuster 420 may be provided symmetrically with respect to a central portion of the fixing frame 200. Hereinafter, in the HMD device 100 according to an embodiment of the present disclosure, a structure of the first length adjuster 410 is described.

The first length adjuster 410 includes the movable member 412 and SMA spring parts 411 and 413, wherein the movable member 412 is mounted on the fixing frame 200 to be movable along the guide member 213 and the SMA spring parts 411 and 413 are mounted on the movable member 412.

The SMA spring parts 411 and 413 include first and second spring parts 411 and 413 mounted on different regions of the fixing frame 200, respectively. The first spring part 411 may be coupled to a first region of the fixing frame 200 adjacent to the guide member 213. The second spring part 413 may be coupled to a second region of the fixing frame 200 spaced apart from the first region of the fixing frame 200 with the guide member 213 between the first region and the second region.

The guide member 213 may further include first and second guide members 213a and 213b provided at one end and another end of the fixing frame 200, respectively, to cover at least a part of the movable member 412. In this case, the first spring part 411 may be disposed between the first and second guide members 213a and 213b, and the second spring part 413 may be disposed to face the first spring part 411.

The first spring part 411 and the second spring part 413 may be mounted on one surface of the movable member 412 and disposed to face each other on a same surface. Alternatively, the first spring part 411 and the second spring part 413 may be mounted on one surface and another surface of the movable member 412, respectively, to be spaced apart from each other on different surfaces.

When the movable member 412 slides in one direction or another direction along the guide member 213, a shape and a size of the movable member 412 are not particularly limited. However, in an embodiment of the present disclosure, the movable member 412 has a rectangular shape.

In the HMD device 100 according to an embodiment of the present disclosure, the SMA spring parts 411 and 413 are electrically connected to the power supply unit 301. According to current applied from the power supply unit 301, the SMA spring parts 411 and 413 may be contracted and deformed to thereby move the movable member 412.

As described above, the SMA herein represents a shape memory alloy, and refers to an alloy with such a property that, even when a shape of the alloy is changed, the alloy returns to an original shape when the alloy is heated. Generally, the SMA is in a form of a coil-shaped SMA spring actuator. The SMA spring has a contraction force as an actuation force, wherein the contraction force is generated when a memorized shape of the SMA spring is recovered at a high temperature after a shape thereof is deformed at a low temperature.

That is, the first and second spring parts 411 and 413 include an SMA material, and may be contracted and deformed when the first and second spring parts 411 and 413 are heated by the current applied from the power supply unit 301.

The headband part 500 is mounted on the movable member 412 and moved according to the movement of the movable member 412 to thereby fit a head size of a human body.

In detail, the headband part 500 is disposed inside the fixing frame 200 and in contact with an occipital region of a user. Thus, the headband part 500 has a shape round and concave toward the central portion of the fixing frame 200 in correspondence with a shape of the occipital region of the user.

At least a part of the headband part 500 may be exposed to outside through the vent hole 201. Thus, the user may wear the HMD device 100 for a long period of time.

The headband part 500 may be mounted on one surface or another surface of the movable member 412, and mounted on a same surface as that of at least one of the first and second spring parts 411 and 413.

Referring to FIG. 1B, the HMD device 100 may include a first cover part 414 formed to have a shape corresponding to that of a part of the fixing frame 200 and disposed to cover the guide member 213 and the first length adjuster 410. The first cover part 414 may protect the guide member 213 and the first length adjuster 410 from outside not to be exposed to outside.

The HMD device 100 may further include a second cover part 302 formed to have a shape corresponding to that of the connecting part 310 and disposed to cover the power supply unit 301. The second cover part 302 may protect the power supply unit 301 from outside not to be exposed to outside.

Hereinafter, a mechanism that is extended or contracted by the first length adjuster 410 so that the headband part 500 gets in contact with the user's head when the user wears the HMD device 100 is described.

FIGS. 2A and 2B are diagrams illustrating a first state viewed from different directions, respectively, in which the headband part 500 is moved in a direction D1 of getting close to the body part 300 in the HMD device according to an embodiment of the present disclosure.

Referring to FIGS. 2A and 2B, the headband part 500 and the first length adjuster 410 connected thereto are mounted on the fixing frame 200, and the fixing frame 200 is mounted and fixed to the body part 300. In this case, the protruding portion 211 may be partially inserted into the connecting part 310 of the body part 300 to be thereby locked and coupled to a locking portion (not shown) provided on the connecting part 310.

The first spring part 411 may include at least one SMA spring. In the HMD device 100 according to an embodiment of the present disclosure, the first spring part 411 includes a first upper spring 411a and a first lower spring 411b. The first upper spring 411a and the first lower spring 411b may be disposed to stack each other between the first and second guide members 213a and 213b.

In addition, one end of the first spring part 411 is coupled to the first region of the fixing frame 200 adjacent to the protruding portion 211, and another end of the first spring part 411 may be coupled to one end of the movable member 412.

That is, since the one end of the first spring part 411 is mounted on the fixing frame 200 that maintains a stopped state with respect to the body part 300, a position of the one end of the first spring part 411 is not changed. On the contrary, since the another end of the first spring part 411 is mounted on the movable member 412 that is mounted to be relatively movable with respect to the fixing frame 200, a position of the another end of the first spring part 411 may be changed according to movement of the movable member 412.

Referring to FIGS. 2A and 2B, the body part 300 may further include the first button unit 311 mounted on the connecting part 310 to be pushed by an external force.

The first button unit 311 is formed to be electrically connected to the power supply unit 301 and the first spring part 411. When the first button unit 311 is pushed by the external force, a signal is transmitted to the power supply unit 301 so that the power supply unit 301 may apply current to the first spring part 411.

That is, when the first button unit 311 is pushed, the first spring part 411 receives current from the power supply unit 301, and thus, a temperature rises. Due to characteristics of the SMA spring such that contraction force is generated when a memorized shape is recovered at a high temperature, the first spring part 411 is deformed in a direction of being contracted according to the contraction force generated at the high temperature.

Accordingly, since the one end of the first spring part 411 is mounted on the first region of the fixing frame 200 and the another end of the first spring part 411 is connected to the movable member 412, the movable member 412 moves in a first direction that is the direction D1 of getting close to the body part 300 according to contraction deformation of the first spring part 411.

In this case, since the second spring part 413 does not receive current from the power supply unit 301, the second spring part 413 may be expanded and deformed in the first direction D1 according to movement of the first spring part 411.

In addition, the movement of the movable member 412 in the first direction D1 may result in movement of the headband part 500 connected to the movable member 412. That is, when the user pushes the first button unit 311, the above-mentioned mechanism is obtained, and the headband part 500 is moved in the first direction D1. Thus, a length of the headband part 500 in contact with the occipital region of the user may be reduced according to a size of the occipital region of the user.

Referring to FIG. 2B, in the first state of the HMD device 100 according to an embodiment of the present disclosure, the first spring part 411 is contracted at a high temperature, the second spring part 413 is expanded at a low temperature, and the movable member 411 is moved in the first direction D1. Thus, at least a part of the movable member 411 is covered by the guide member 213. In addition, in the first state, a space between the fixing frame 200 and the headband part 500 is relatively increased.

FIGS. 3A and 3B are diagrams illustrating a second state viewed from different directions, respectively, in which the headband part 500 is moved in a direction D2 of getting away from the body part 300 in the HMD device according to an embodiment of the present disclosure.

The second spring part 413 may include at least one SMA spring. In the HMD device 100 according to an embodiment of the present disclosure, the second spring part 413 includes a second upper spring 413a and a second lower spring 413b.

In addition, one end of the second spring part 413 may be mounted on another end of the movable member 412. Accordingly, the one end of the second spring part 413 may be disposed adjacent to the another end of the first spring part 411. Another end of the second spring part 413 may be coupled to the second region of the fixing frame 200 spaced apart from the first region.

That is, since the one end of the second spring part 413 is mounted on the movable member 412 that is mounted to be relatively movable with respect to the fixing frame 200, a position of the one end of the second spring part 413 may be changed according to movement of the movable member 412. However, since the another end of the second spring part 413 is mounted on the fixing frame 200 that maintains a stopped state with respect to the body part 300, a position of the another end of the second spring part 413 is not changed.

Referring to FIG. 3A, the second spring part 413 may further include the second button unit 312 mounted on the connecting part 310 to push the body part 300 by an external force.

The second button unit 312 is formed to be electrically connected to the power supply unit 301 and the second spring part 413. When the second button unit 312 is pushed by the external force, a signal is applied to the power supply unit 301 so that the power supply unit 301 may apply current to the second spring part 413.

That is, when the second button unit 312 is pushed, the second spring part 413 receives the current from the power supply unit 301, and thus, a temperature rises. Due to characteristics of the SMA spring such that contraction force is generated when a memorized shape is recovered at a high temperature, the second spring part 413 is deformed in a direction of being contracted according to the contraction force generated at the high temperature.

Accordingly, since the one end of the second spring part 413 is mounted on the second region of the fixing frame 200 and the another end of the second spring part 413 is connected to the movable member 412, the movable member 412 moves in a second direction that is the direction D2 of getting far away from the body part 300 according to contraction deformation of the second spring part 413.

In this case, since the first spring part 411 does not receive current from the power supply unit 301, the first spring part 411 may be expanded and deformed in the second direction D2 according to the movement of the movable member 412.

In addition, the movement of the movable member 412 in the second direction D2 may result in movement of the headband part 500 connected to the movable member 412. That is, when the user pushes the second button unit 312, the above-mentioned mechanism is obtained and the headband part 500 is moved in the second direction D2. Thus, a length of the headband part 500 in contact with the occipital region of the user may be extended according to a size of the occipital region of the user.

In the present disclosure, in such a structure, the power supply unit 301 may selectively apply current to the first and second spring parts 411 and 413 to thereby move the movable member 412 in the first direction D1 or the second direction D2. According to the movement of the movable member 412, a length of the headband part 500 mounted on the movable member 412 may be adjusted.

Accordingly, as the present disclosure provides the SMA spring parts 411 and 413 that may be contracted by heat, a length of the headband part 500 connected to the SMA spring parts 411 and 413 may be automatically adjusted according to a deformation direction of the SMA spring.

In addition, as a length of the headband part 500 preset by the user may be repeatedly implemented, a user's wearing comfort may be enhanced. Also, the headband part 500 gets in contact with the occipital region of the user sequentially step-by-step, the headband part 500 may easily and closely fit the occipital region of the user.

To implement such a structure, the body part 300 may further include a memory unit (not shown) configured to store a positional state of the headband part 500 according to a head size of a user, and a controller (not shown) electrically connected to the power supply unit 301 and the memory unit.

In addition, the controller may transmit a signal to the power supply unit 301 so that the headband part 500 is disposed in the stored positional state according to a user's selection.

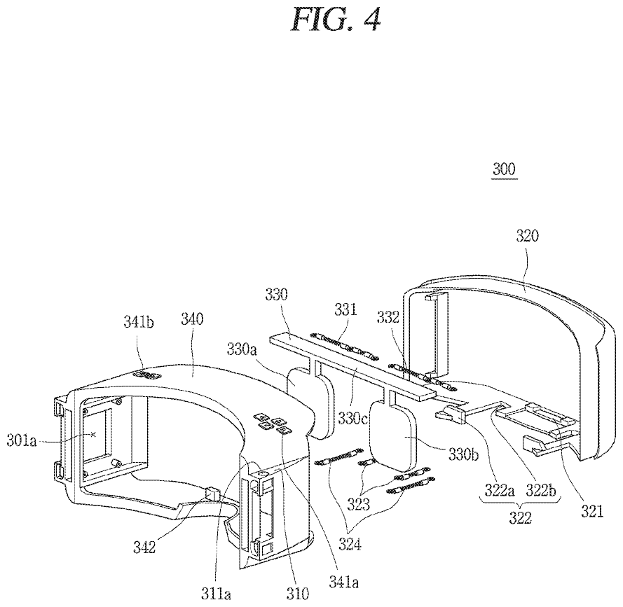

FIG. 4 is an exploded perspective view of the body part 300 of the HMD device 100 according to an embodiment of the present disclosure.

Referring to FIG. 4, the body part 300 may include a first housing 320 including a display unit (not shown) to output a virtual reality image, a second housing 340 including the power supply unit 301 to supply power, and a lens unit 330 disposed in an inner space formed by the first and second housings 320 and 340.

The display unit (not shown) may project an image to the user's eyes using a prism. Further, the prism may be formed to be transmissive so that the user may view the projected image and a general front (in a range in which the user views through eyes) together. Such an image output via the display unit may overlap the general view when the user views the image. The HMD device 100 may also provide augmented reality (AR), in which a virtual image superimposed on a real image or a background is displayed as a single image. using characteristics of such a display.

The power supply unit 301 is installed to be connected to the controller and a battery unit to apply current. The power supply unit 301 is not particularly limited when it is an ordinary general power supply unit to apply current in the art. Here, the power supply unit 301 may be connected to the controller and the battery unit by electric wires. Also, the power supply unit 301 may be formed integrally with the controller.

The power supply unit 301 includes a battery. The battery may be an internal battery or a replaceable battery. Hereinafter, the power supply unit 301 is referred to as the battery.

As described above, the body part 300 may include the front surface constituting the outer appearance, and the rear surface disposed in a position opposite to that of the front surface and in contact with the face surface of the user.

The first housing 320 may constitute a part of the outer appearance of the body part 300. That is, the first housing 320 may constitute an external case including a space or a structure in which a mobile terminal may be coupled to the front surface. The external case of the body part 300 may correspond to an outer shape of the mobile terminal.

In addition, in the present disclosure, the first housing 320 may be mounted slidably with respect to the second housing 340, and a coupling element that couples the first housing 320 to the second housing 340 may be included.

Referring to FIG. 4, the coupling element is provided on one side of the first housing 320. The coupling element may include a first coupling part 321, a second coupling part 322, and housing spring parts 323 and 324.

The first coupling part 321 may be disposed to overlap one region of the second housing 340 to thereby couple the first housing 320 to the second housing 340.

The second coupling part 322 may include a protruding portion 322a and a recess portion 322b. The protruding portion 322a may be provided to protrude further than the first coupling part 321 so that the protruding portion 332 is locked on a part of the second housing 340. The recess portion 322b may be provided between the protruding portion 322a and the first coupling part 321 and recessed in a direction opposite to a protruding direction of the protruding portion 322a.

The housing spring parts 323 and 324 are configured such that the first housing 320 may slide relatively with respect to the second housing 340. The housing spring parts 323 and 324 may include a first housing spring part 323 and a second housing spring part 324.

One end of the first housing spring part 323 may be mounted on the first coupling part 321 in one direction. One end of the second housing spring part 324 may be mounted on the second coupling part 322 in the one direction. Another end of each of the first and second housing spring parts 323 and 324 may be mounted on the second housing 340, which will be described later.

The second housing 340 together with the first housing 320 may constitute a part of the outer appearance of the body part 300. That is, the second housing 340 together with the first housing 320 may constitute a side surface and a rear surface of the body part 300, other than a front surface of the body part 300.

In addition, the second housing 340 may include a third coupling part 342 coupled to the second coupling part 322 in a position corresponding to the second coupling part 322. The third coupling part 342 is provide to protrude from one surface of the second housing 340 in a thickness direction of the second housing 340. A portion of the protrusion of the third coupling part 342 may be accommodated in the recess portion 322b of the second coupling part 322.

Additionally, the second housing 340 may further include operation units 341a and 341b formed on one side of the second housing 340, and a battery hole 301a accommodating the battery 301. The operation units 341a and 341b may include a control device or a user input module that may control the mobile terminal. The control device may include, for example, at least one selected from a touch pad, a physical key, a physical button, a touch key, a joystick, or a wheel key, each on a side of the body part 300.

The lens unit 330 may include a pair of lenses 330a and 330b corresponding to left and right eyes of the user, respectively, and a lens support part 330c provided to support the pair of lenses 330a and 330b.

In detail, the pair of lenses 330a and 330b are mounted on the lens support part 330c to be relatively movable with respect to the lens support part 330c. The pair of lenses 330a and 330b may be selectively and individually moved in one direction or another direction. That is, the pair of lenses 330a and 330b are detachably mounted on the lens support part 330c.

In addition, to implement such a structure, the lens unit 330 may further include a moving element mounted on the lens supporting part 330c. In the HMD device 100 according to an embodiment of the present disclosure, the moving element may be the lens spring parts 331 and 332.

The lens spring parts 331 and 332 may include a first lens spring part 331 corresponding to a left eye lens and a second lens spring part 332 corresponding to a right eye lens, among the pair of lenses 330a and 330b. The first and second lens spring parts 331 and 332 may each include a contraction spring and a relaxation spring. A mechanism related to the lens spring parts 331 and 332 will be described later.

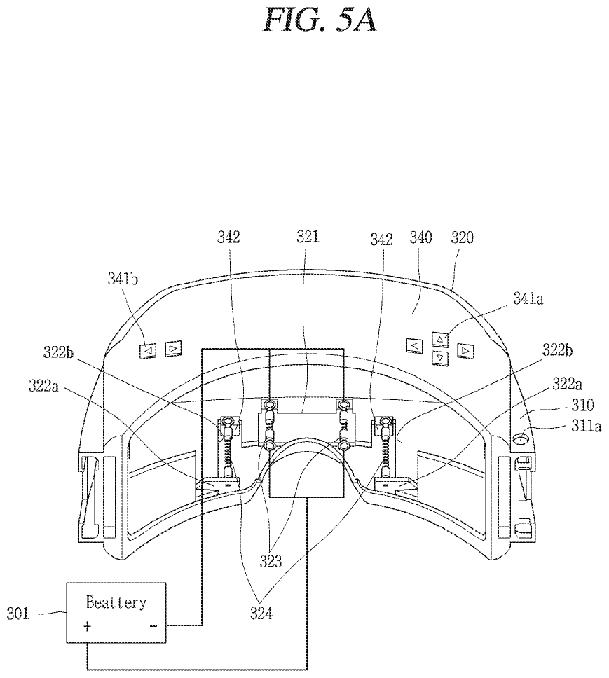

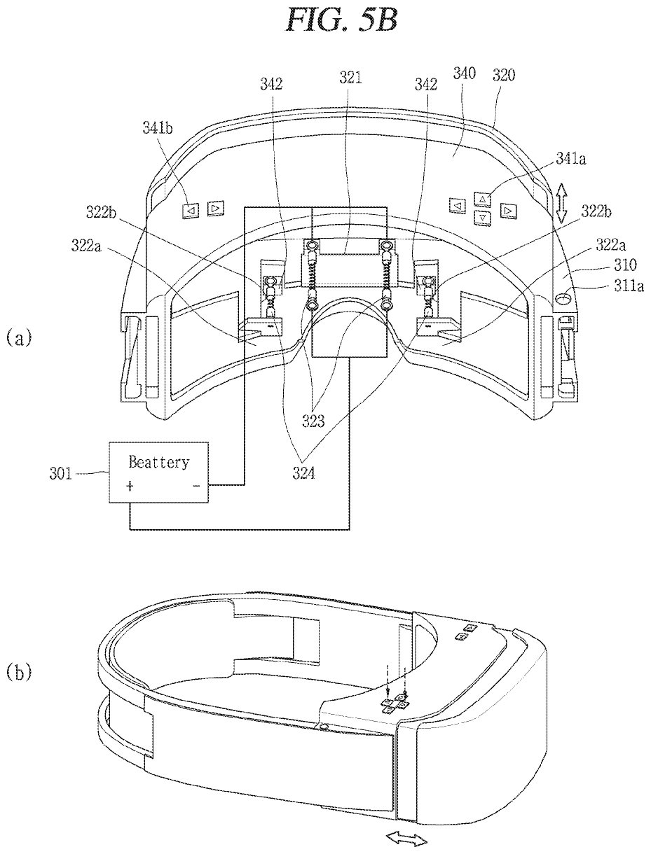

FIGS. 5A and (a) of 5B illustrate the first state in which the first and second housings 320 and 340 are coupled to each other and the second state in which the first and second housings 320 and 340 are separate from each other, and thus, the body part 300 is expanded, respectively, in the HMD device according to an embodiment of the present disclosure. (b) of FIG. 5B is a diagram illustrating the second state of (a) of FIG. 5B viewed from another direction.

Hereinafter, a structure in which, when a user operates the operation units 341a and 341b, the first housing 320 may move relatively with respect to the second housing 340 to thereby adjust a distance between the display and the user and, resultantly, the user may adjust a position of the display unit to view an image suitable for an eyesight of the user or displayed optimally, is described.

Referring to FIGS. 5A and 5B, as the first and second coupling parts 321 and 322 of the first housing 320 are coupled to the third coupling part 342 of the second housing 340, the first and second housings 320 and 340 may be coupled to each other.

In this case, with respect to the HMD device 100 according to an embodiment of the present disclosure, a structure in which the body part 300 may be expanded according to a size of a mobile terminal seated in the body part 300 is proposed.

Referring to FIGS. 5A and 5B, the battery 301 is electrically connected to the housing spring parts 323 and 324 to selectively apply current to the first housing spring part 323 or the second housing spring part 324.

The first housing spring part 323 is mounted on the first and second housings 320 and 340. In detail, the one end of the first housing spring part 323 may be mounted on the first coupling part 321 of the first housing 320. The another end of the first housing spring part 323 may be mounted on the one region of the second housing 340. In addition, the one end of the second housing spring part 324 is mounted on the third coupling part 342 of the second housing 340. The another end of the second housing spring part 324 is mounted on the protruding portion 322a of the first housing 320.

Referring to FIG. 5A, according to direction keys provided on the operation unit 341a, the body part 300 may be contracted from an expanded state. In this case, as the operation unit 341a in a preset direction is pushed by the user, the battery 301 operates to apply current to the first housing spring part 323. Then, due to characteristics of the SMA spring such that contraction force is generated when a memorized shape is recovered at a high temperature, the contraction force is generated in the first housing spring part 323 at a high temperature according to the applied current, and thus, contraction deformation may occur in the first housing spring part 323.

That is, according to the contraction deformation of the first housing spring part 323, since the first housing 320 connected to the one end of the first housing spring part 323 is to move in a direction of the contraction deformation, the first housing 320 may move in a direction of getting close to the second housing 340. Thus, the first and second housings 320 and 340 may implement the first state in which the first and second housings 320 and 340 are closest to each other.

Referring to each of (a) and (b) of FIG. 5B, according to the direction keys provided on the operation unit 341a, the body part 300 may be expanded from a contraction state, that is, the first state. In this case, as the operation unit 341a in a preset direction is pushed by the user, the battery 301 operates to apply current to the second housing spring part 324. Then, due to characteristics of the SMA spring such that contraction force is generated when a memorized shape is recovered at a high temperature, the contraction force is generated in the second housing spring part 324 at a high temperature according to the applied current, and thus, contraction deformation may occur in the second housing spring part 324.

That is, according to the contraction deformation of the second housing spring part 324, since the first housing 320 connected to the another end of the second housing spring part 324 is to move in a direction of the contraction deformation, the first housing 320 may move in a direction of getting away from the second housing 340. Thus, the first and second housings 320 and 340 may implement the second state in which the first and second housings 320 and 340 are spaced apart from each other, that is, the body part 300 is expanded.

As such, the present disclosure provides such a structure in which terminals having a plurality of sizes may be seated in the body part 300 and a distance may be adjusted so that a user may view images in various sizes even when one display is provided.

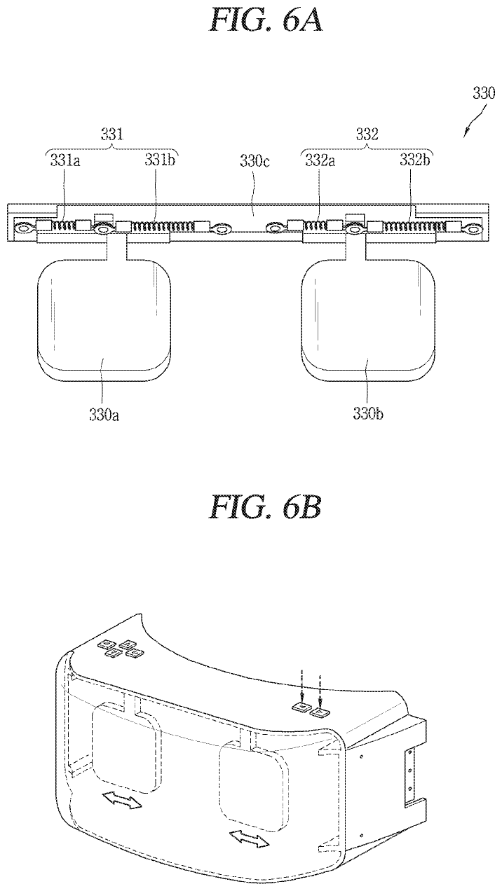

FIGS. 6A and 6B are diagrams of the lens unit 330 in the HMD device according to an embodiment of the present disclosure.

Hereinafter, a structure in which, when a user operates the operation units 341a and 341b, the lens unit 330 is moved to thereby adjust a distance between the lens unit 330 and the user, and thus, the user may adjust a position of the lens unit 330 to view an image suitable for an eyesight of the user or displayed optimally is described.

Referring to FIG. 6A, among the lens spring parts 331 and 332, the first lens spring part 331 is mounted in correspondence with one of the pair of lenses 330a and 330b. In an embodiment of the present disclosure, the first lens spring part 331 may be mounted on the lens supporting part 330c in correspondence with a left-eye lens 330a among the pair of lenses 330a and 330b. The second lens spring part 332 may be mounted on the lens support part 330c in correspondence with a right-eye lens 330b among the pair of lenses 330a and 330b. In this case, the present disclosure proposes a structure of the HMD device 100 in which a lens distance may be adjusted according to a user to thereby adjust a focus.

The lens unit 330 includes a first lens and a second lens among the pair of lenses 330a and 330b, that is, the left-eye lens 330a and the right-eye lens 330b corresponding to left and right eyes of a user, respectively. The first and second lens spring parts 331 and 332 include an SMA spring provided to be contracted and deformed according to current applied from the battery 301.

The first lens spring part 331 includes a relaxation spring and a contraction spring spaced apart from each other with the first lens 330a therebetween. The second lens spring part 332 may further include a relaxation spring and a contraction spring spaced apart from each other with the second lens 330b therebetween.

That is, the first and second lens spring parts 331 and 332 each include the contracting spring and the relaxation spring. The contracting spring and the relaxation spring are electrically connected to the battery 301.

Referring to FIG. 6B, for example, when the battery 301 selectively applies current to the contraction spring or the relaxation spring in the first lens spring part 331, a particular spring to which the current is applied has a contraction force, and thus, contraction deformation occurs in the particular spring. That is, depending on a spring to which the battery 301 applies the current, the first lens 330a connected to the first lens spring part 311 may be selectively moved in one direction or another direction.

This structure may be also applied to the second lens spring part 332. Accordingly, in the present disclosure, a distance between the user and the lens unit 330 may be automatically adjusted.

At least some of respective components described above may operate in cooperation with each other to thereby implement an operation, control, or a control method with respect to the HMD device 100 according to various embodiments described below. Also, the operation, the control, or the control method with respect to HMD device 100 may be implemented on the HMD device 100 by driving at least one application program stored in the memory.

The present disclosure described above can be implemented as computer-readable codes on a program-recorded medium. The computer readable medium includes all kinds of recording devices in which data readable by a computer system is stored. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). The above detailed description should not be limitedly construed in all aspects and should be considered as illustrative. The scope of the present disclosure should be determined by rational interpretation of the appended claims, and all changes within the scope of equivalents of the present disclosure are included in the scope of the present disclosure.

### INDUSTRIAL APPLICABILITY

Embodiments of the present disclosure propose such a structure that a spring part including a shape memory alloy (SMA) with a property of being contracted and deformed by heat and a movable member connected to the spring part are provided, a headband part in contact with an occipital region of a user is connected to the movable member, and thus, the headband part may be selectively deformed in a direction of contraction or relaxation according to supply of current. Accordingly, these embodiments may be applied to various relevant industrial fields.

1. A head-mounted display device, the device comprising:
a body part comprising a power supply unit that supplies power;
a fixing frame mounted on the body part and comprising a guide member provided adjacent to the body part;
a length adjustment part comprising a movable member mounted on the fixing frame to be movable along the guide member, and a shape memory alloy spring part that is mounted on the movable member and moves the movable member by being contracted according to current applied from the power supply unit; and
a headband part mounted on the movable member and moved according to the movement of the movable member to thereby fit a head size of a human body,
wherein the shape memory alloy spring part comprises a first spring part coupled to a first region of the fixing frame adjacent to the guide member, and a second spring part coupled to a second region of the fixing frame spaced apart from the first region with the guide member between the first region and the second region.

2. The device of claim 1, wherein the guide member comprises first and second guide members provided at one end and another end of the fixing frame, respectively, to cover at least a part of the movable member and disposed to face each other, and
wherein the first spring part is provided between the first and second guide members and moves the movable member in a first direction of getting close to the body part.

3. The device of claim 2, wherein the second spring part is disposed to face the first spring part and moves the movable member in a second direction of getting away from the body part.

4. The device of claim 3, wherein the fixing frame comprises:
a first end coupled adjacent to a first side of the body part, and a second end coupled adjacent to a second side of the body part, the second side being disposed to face the first side; and
a protruding portion that is provided to extend and protrude from one of the first and second ends in the first direction, and couples the fixing frame to the body part by being inserted into one of the first and second sides disposed to face the one of the first and second ends.

5. The device of claim 4, wherein the fixing frame comprises a vent hole provided between the first and second ends to thereby expose at least a part of the headband part to outside of the fixing frame.

6. The device of claim 4, wherein the body part comprises a connecting part that forms an inner space and is provided on at least one of the first and second sides to thereby accommodate the protruding portion, and
wherein the power supply unit comprises a battery unit provided in the inner space of the connecting part and electrically connected to the first and second spring parts to selectively apply current to the first or second spring part.

7. The device of claim 6, wherein the body part comprises:
a first button unit that is mounted on the connecting part to be pushed by an external force, is electrically connected to the battery unit and the first spring part, and transmits a signal to the battery unit so that the battery unit applies current to the first spring part, when the first button unit is pushed by the external force; and
a second button unit that is mounted on the connecting part to be pushed by an external force, is electrically connected to the battery unit and the second spring part, and transmits a signal to the battery unit so that the battery unit applies current to the second spring part, when the second button unit is pushed by the external force.

8. The device of claim 7, wherein the fixing frame comprises a band hole provided adjacent to the guide member, and
wherein the headband part is connected to the movable member through the band hole, and moves along the movable member so that a distance between the headband part and the fixing frame increases, when the movable member moves in the first direction.

9. The device of claim 8, wherein the headband part is provided to have a shape that is round and concave toward a central portion of the fixing frame to correspond to a shape of an occipital region of a user.

10. The device of claim 8, comprising:
a first cover part provided in correspondence with a part of the fixing frame to cover the guide member and the length adjustment part; and
a second cover part provided in correspondence with the battery unit to cover the battery unit, and disposed to be inserted into the connecting part.

11. The device of claim 1, comprising:
a first housing comprising a display unit to output a virtual reality image, and a second housing;
a lens unit disposed in an inner space formed by the first and second housings and comprising a first lens and a second lens corresponding to a left eye and a right eye of a user, respectively; and
a coupling element that couples the first housing to the second housing so that the first housing is slidable with respect to the second housing.

12. The device of claim 11, wherein the coupling element comprises:
a first coupling part that is provided on one surface of the first housing and connects the first housing to the second housing by being disposed to overlap one surface of the second housing; and
a second coupling part provided adjacent to the first coupling part, and comprising a protruding portion and a recess portion, wherein the protruding portion is provided to protrude from the one surface of the first housing and the recess portion is recessed in a direction different from a protruding direction of the protruding portion.

13. The device of claim 12, wherein the second housing comprises a third coupling part provided to protrude from the one surface of the second housing to be accommodated in the recess portion, and
wherein the protruding portion is in contact with and connected to one end of the second housing when the third coupling part is accommodated in the recess portion.

14. The device of claim 13, wherein the coupling element further comprises a housing shape memory alloy spring part provided to be contracted and deformed by current applied from the power supply unit, and
wherein the housing shape memory alloy spring part comprises:
a first housing shape memory alloy spring having one end being mounted on the first coupling part and another end being mounted on the one surface of the second housing; and
a second housing shape memory alloy spring having one end being mounted on the third coupling part and another end being mounted on the protruding portion.

15. The device of claim 14, wherein the body part is provided to selectively implement a first state in which the second housing is moved in a direction of getting close to the first housing, as the first spring part is contracted and deformed by current applied from the power supply unit; and
a second state in which the body part is expanded as the second housing is moved in a direction of getting away from the first housing, when the second spring part is contracted and deformed by current applied from the power supply unit.

16. The device of claim 15, wherein the lens unit comprises:
a lens support part which is provided to support the first and second lenses, and in which the first and second lenses are mounted to be spaced apart from each other; and
a moving element that relatively moves the first and second lenses in a same direction or different directions with respect to the lens supporting part.

17. The device of claim 16, wherein the moving element comprises:
a first lens spring part that is mounted on the lens support part to be disposed adjacent to the first lens, and moves the first lens in a predetermined direction by being connected to the first lens; and
a second lens spring part that is mounted on the lens support part to be disposed adjacent to the second lens, and moves the second lens in a predetermined direction by being connected to the second lens.

18. The device of claim 17, wherein at least one of the first and second housings comprises a button unit provided to be pushed by an external force, and electrically connected to the power supply unit, the housing shape memory alloy spring part, and the lens shape memory alloy spring part.

19. The device of claim 17, wherein the first and second lens spring parts comprise a shape memory alloy spring provided to be contracted and deformed by the current applied from the power supply unit,
wherein the first lens spring part comprises relaxation and contraction springs spaced apart from each other with the first lens therebetween, and wherein the second lens spring part comprises relaxation and contraction springs spaced apart from each other with the second lens therebetween.

20. The device of claim 1, wherein the body part further comprises:
a memory unit configured to store a positional state of the headband part according to a head size of a user; and
a controller electrically connected to the power supply unit and the memory unit, and configured to transmit a signal to the power supply unit so that the headband part is arranged in the stored positional state, according to a user's selection.
